(19) United States
(12) Patent Application Publication
(10) Pub. No.: US 2019/0311716 A1
(43) Pub. Date: Oct. 10, 2019

(54) DIALOG DEVICE, CONTROL METHOD OF DIALOG DEVICE, AND A NON-TRANSITORY STORAGE MEDIUM

(71) Applicant: SHARP KABUSHIKI KAISHA, Sakai City, Osaka (JP)

(72) Inventors: KAZUNORI MORISHITA, Sakai City (JP); SHINYA SATOH, Sakai City (JP); HIROYASU IGAMI, Sakai City (JP); NAOKI ESUMI, Sakai City (JP)

(73) Assignee: SHARP KABUSHIKI KAISHA, Sakai City, Osaka (JP)

(21) Appl. No.: 16/339,166

(22) PCT Filed: Aug. 24, 2017
(86) PCT No.: PCT/JP2017/030408

§ 371 Date: Apr. 3, 2019

(30) Foreign Application Priority Data
Oct. 6, 2016 (JP) 2016-198479

(51) Int. Cl. G10L 15/22; G10L 15/30; G10L 13/04

(52) U.S. Cl. CPC G10L 15/22; G10L 15/30; G06F 17/2755; G10L 2015/223; G10L 13/043

(57) ABSTRACT

A completion processing section (23) is configured to, if a user's speech inputted to an interactive device (1) omits some phrase, complete the speech of the user. A speech storing section (25) stores a user's speech having no omitted or incorrect phrases in a speech database (50) for use in generation of a speech of the interactive device (1). User's previous speech data thus stored are made effective use of for generation of a speech of the interactive device.

### TECHNICAL FIELD

The present invention relates to an interactive device, a method of controlling an interactive device, and a control program. For example, the present invention relates to an interactive device that converses with a user by voice or text.

### BACKGROUND ART

Interactive devices that converse with a user by voice or text have conventionally been developed. For example, Patent Literature 1 discloses an interactive device that converses with a user by voice. Some of the interactive devices are configured to: store user's speeches in a database; and use user's previous speeches stored in the database to generate a speech of the interactive device.

### CITATION LIST

### Patent Literature

[Patent Literature 1]

Japanese Patent Application Publication, Tokukai, No. 2015-87728 (Publication date: May 7, 2015)

### SUMMARY OF INVENTION

### Technical Problem

However, a user sometimes omits some phrase in his/her speech. For example, in a case where the interactive device says “(Do you) like apples?”, the user may say “Sure” (the subject is omitted), “Yes” (answer is shortened), or the like, instead of saying “(I) like apples”. In such cases, the interactive device is sometimes unable to make effective use of the user's speech in generating a speech of the interactive device. One way to construct a more valuable database would be to complete the user's speech and store it in the database; however, if the interactive device completes the user's speech by adding a seemingly omitted phrase, the completed user's speech may be incorrect. That is, the completed user's speech may be different from the user's intended one. Such an incorrectly completed user's speech cannot be made effective use of in generation of a speech of the interactive device in some cases.

The present invention was made in view of the above issue, and an object thereof is, by storing a user's speech in a state with no omissions or incorrect parts, to make effective use of the stored user's previous speech in order to generate a speech of the interactive device.

### Solution to Problem

In order to attain the above object, an interactive device in accordance with one aspect of the present invention is an interactive device configured to converse with a user by voice or text, including: a speech completion section configured to, if a speech of the user inputted to the interactive device lacks some phrase, complete the speech of the user on the basis of at least one of a previous speech of the interactive device and a previous speech of the user; a correct/incorrect determination section configured to determine whether the speech of the user completed by the speech completion section is correct or incorrect on the basis of a specified determination condition; a speech storing section configured to, if the correct/incorrect determination section determines that the speech of the user is correct, store information of the speech of the user in a speech database; and a speech generation section configured to generate a speech of the interactive device with use of the speech of the user that has been stored in the speech database by the speech storing section.

In order to attain the above object, a method of controlling an interactive device in accordance with one aspect of the present invention is a method of controlling an interactive device that is configured to converse with a user by voice or text, the method including: a speech completing step including, if a speech of the user inputted to the interactive device lacks some phrase, completing the speech of the user on the basis of at least one of a previous speech of the interactive device and a previous speech of the user; a correct/incorrect determining step including determining whether the speech of the user completed in the speech completing step is correct or incorrect on the basis of a specified determination condition; a speech storing step including, if it is determined in the correct/incorrect determining step that the speech of the user is correct, storing information of the speech of the user in a speech database that is for use in generation of a speech of the interactive device; and a speech generating step including generating the speech of the interactive device with use of the speech of the user that has been stored in the speech database in the speech storing step.

### Advantageous Effects of Invention

According to one aspect of the present invention, it is possible, by storing a user's speech in a state with no omissions or incorrect parts, to make effective use of the stored user's previous speech in order to generate a speech of an interactive device.

### BRIEF DESCRIPTION OF DRAWINGS

FIG. 1 is a block diagram illustrating a configuration of an interactive device in accordance with Embodiment 1.

FIG. 2 is a flowchart showing a flow of a speech information obtaining process carried out by a control section of the interactive device in accordance with Embodiment 1.

FIG. 3 is a flowchart showing a flow of a speech generation process carried out in the speech information obtaining process shown in FIG. 2.

FIG. 4 illustrates one example of a data structure of a scenario database stored in the interactive device in accordance with Embodiment 1.

FIG. 5 is a flowchart showing a flow of a speech completion process carried out in the speech information obtaining process shown in FIG. 2.

FIG. 6 is a flowchart showing a flow of a speech storing process carried out in the speech information obtaining process shown in FIG. 2

FIG. 7 illustrates one example of a data structure of a speech database stored in the interactive device in accordance with Embodiment 1.

FIG. 8 illustrates one example of a data structure of a category table included in the interactive device in accordance with Embodiment 1.

FIG. 9 is a flowchart showing a flow of a speech storing process in accordance with Embodiment 2.

FIG. 10 is a flowchart showing a flow of a speech confirmation process in accordance with Embodiment 3.

### DESCRIPTION OF EMBODIMENTS

### Embodiment 1

The following description will discuss embodiments of the present invention in detail.

(Configuration of Interactive Device 1)

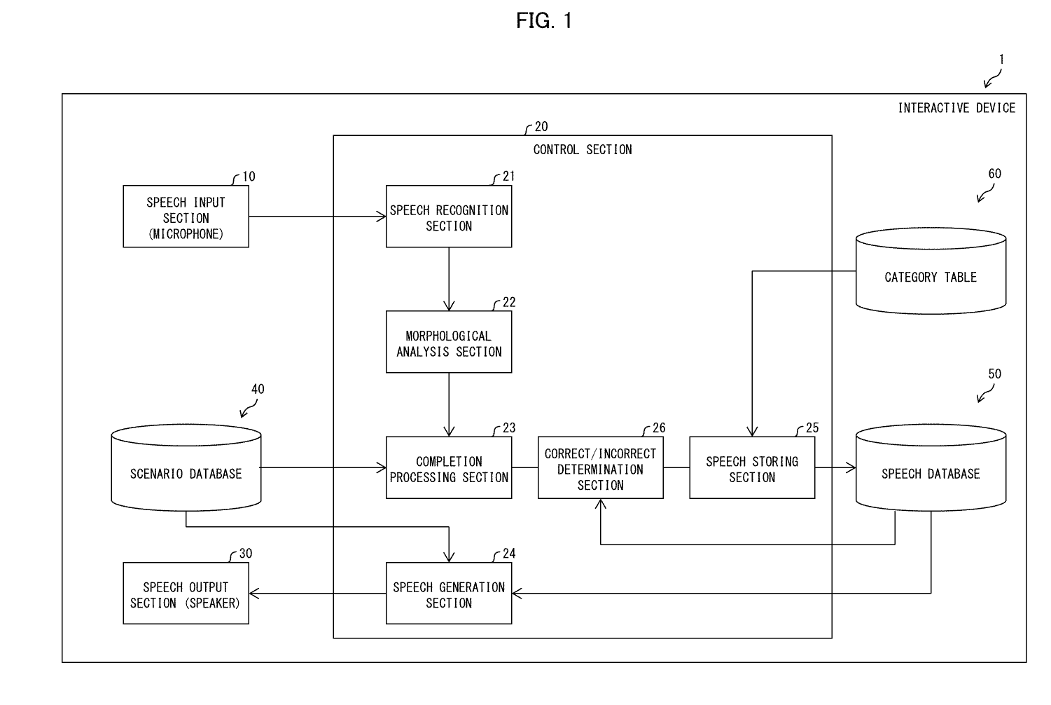

The following description will discuss a configuration of the interactive device 1 in accordance with Embodiment 1, with reference to FIG. 1. The interactive device 1 is a machine (e.g., a robot) that converses by voice with a user. FIG. 1 is a block diagram illustrating a configuration of the interactive device 1. In one variation, the interactive device 1 may converse by text with a user.

As illustrated in FIG. 1, the interactive device 1 includes a speech input section 10, a control section 20, and a speech output section 30. Furthermore, the interactive device 1 stores therein a scenario database 40, a speech database 50, and a category table 60. The interactive device 1 also stores therein a recognition dictionary (not illustrated) for use in recognition of a user's speech by a speech recognition section 21 (described later). The recognition dictionary states therein a correspondence relationship between speeches detected by the speech input section 10 and words or phrases indicated by the speeches.

The speech input section 10 detects a user's speech, and generates speech data that corresponds to the user's speech. The speech input section 10 is, specifically, a microphone. The speech data detected by the speech input section 10 is transmitted to the control section 20.

The control section 20 generates a speech of the interactive device 1. The control section 20 carries out speech recognition of the user's speech detected by the speech input section 10 to thereby obtain information of the user's speech, and stores the obtained information in the speech database 50. As illustrated in FIG. 1, the control section 20 includes the speech recognition section 21, a morphological analysis section 22, a completion processing section 23 (speech completion section), a speech generation section 24, a speech storing section 25, and a correct/incorrect determination section 26. The processes carried out by the respective sections of the control section 20 will be described later when describing a speech information obtaining process.

The speech output section 30 outputs the speech of the interactive device 1, which is generated by the control section 20, in the form of a sound. The speech output section 30 is, specifically, a speaker. In one variation, the interactive device 1 may output the speech of the interactive device 1 in text form.

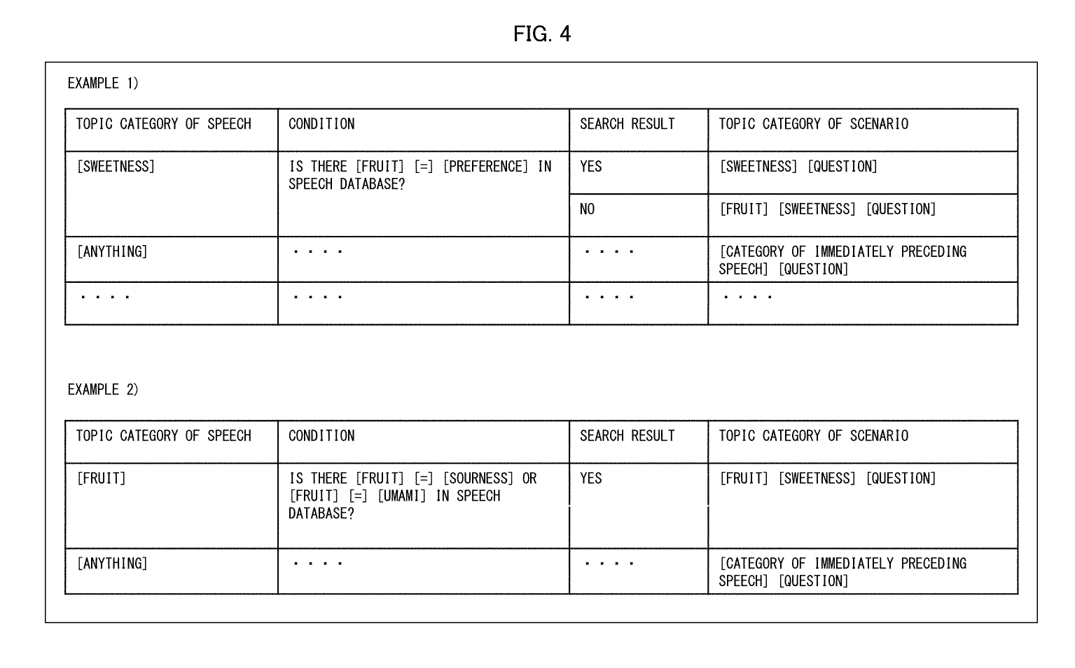

The scenario database 40 stores therein scenarios for use in generation of a speech of the interactive device 1. The scenarios include question scenarios (see FIG. 4), which will be described later. The speech database 50 stores therein information of previous speeches of the interactive device 1 and information of previous speeches of a user(s). In the category table 60, words and their corresponding categories are associated with each other. The category of a word in a speech is in relation to the topic of the speech, in many cases. The category of a word is hereinafter referred to as “topic category”. One example of the scenario database 40, one example of the speech database 50, and one example of the category table 60 will be described later. Note that some or all of the data stored in the scenario database 40, the speech database 50, the category table 60, and the like may be stored in a distributed manner on a network. In such an arrangement, the data stored in the scenario database 40, the speech database 50, the category table 60, and the like may be provided to the interactive device 1 via the Internet on a regular or irregular basis. The control section 20 may also reside on a server on the Internet. In this arrangement, the control section 20 on the server may control the speech input section 10 and the speech output section 30 of the interactive device 1 via the Internet, home network (e.g., wireless LAN), and/or the like.

(Flow of Speech Information Obtaining Process)

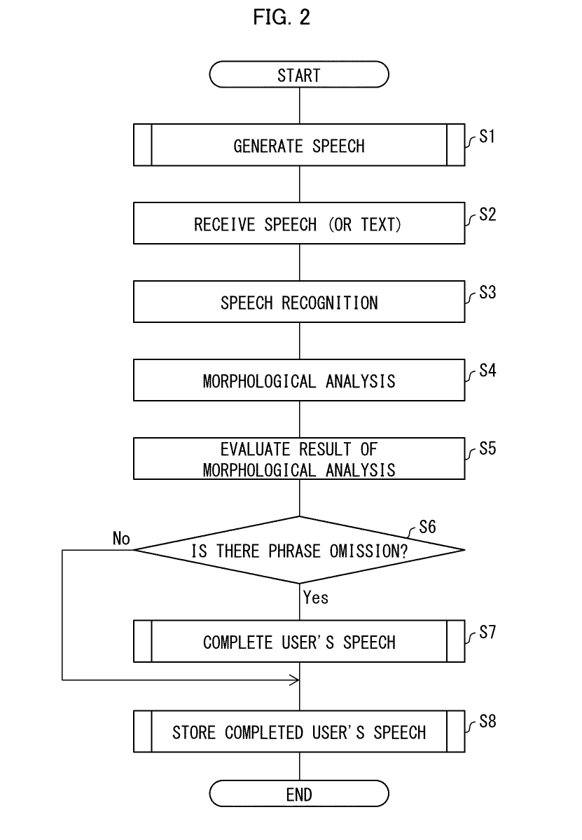

The following description will discuss a flow of a speech information obtaining process carried out by the control section 20, with reference to FIG. 2. FIG. 2 is a flowchart showing the flow of the speech information obtaining process.

As shown in FIG. 2, in the speech information obtaining process, first, the speech generation section 24 generates a speech of the interactive device 1 (S1). Alternatively, a user may provide a speech to the interactive device 1 first. In either case, the speech input section 10 detects the user's speech, and generates speech data that corresponds to the user's speech. The speech generation process (S1) will be described later.

The speech recognition section 21 receives, from the speech input section 10, the speech data that corresponds to the user's speech (S2, speech obtaining step). The speech recognition section 21 carries out a speech recognition process with respect to the speech data received from the speech input section 10, and thereby converts the speech data that corresponds to the user's speech into text data (S3). The speech recognition section 21 may be configured such that, if the speech recognition fails, the speech recognition section 21 requests the user to speak again by use of a display notification, a sound notification, or the like notification or waits until the user speaks again. The speech recognition section 21 supplies, to the morphological analysis section 22, the result of the speech recognition (i.e., text data that corresponds to the user's speech). The speech recognition section 21 may be configured such that, even if the speech recognition fails, the speech recognition section 21 supplies the result of the speech recognition to the morphological analysis section 22. Note that, in a case where the interactive device 1 is a machine that converses with a user by text, the morphological analysis section 22 in step S2 receives text inputted by the user, and the foregoing step S3 is omitted. In the following descriptions, the text data obtained as a result of speech recognition or as a result of text input is referred to as user's speech data.

The morphological analysis section 22 carries out a morphological analysis of the user's speech data obtained from the speech recognition section 21 (S4). Specifically, the morphological analysis section 22 breaks the user's speech into morphemes (e.g., words), each of which is the smallest meaningful unit in the grammar of a language. The morphological analysis is an existing technique, and therefore descriptions therefor are omitted here.

Next, the morphological analysis section 22 evaluates the result of the morphological analysis (S5). Specifically, the morphological analysis section 22 determines whether the user's speech omits a phrase or not. Note here that a phrase is made up of one or more words.

If it is determined that the user's speech omits a phrase (Yes in S6), the completion processing section 23 completes the user's speech by adding a seemingly omitted phrase (e.g., subject, predicate, modifier) based on at least one of the immediately preceding speech of the interactive device 1 and a previous speech of a user (S7, speech completing step). A flow of the speech completion process (S7) carried out by the completion processing section 23 will be described later. On the other hand, if it is determined that the user's speech does not omit any phrase (No in S6), the completion processing section 23 does not carry out the speech completion process.

The speech storing section 25 obtains the user's speech data from the completion processing section 23. As described earlier, if it is determined that the user's speech omits some phrase, the completion processing section 23 completes the user's speech by adding a seemingly omitted phrase in step S7. Therefore, the user's speech that the speech storing section 25 obtains is a complete speech having no phrases omitted.

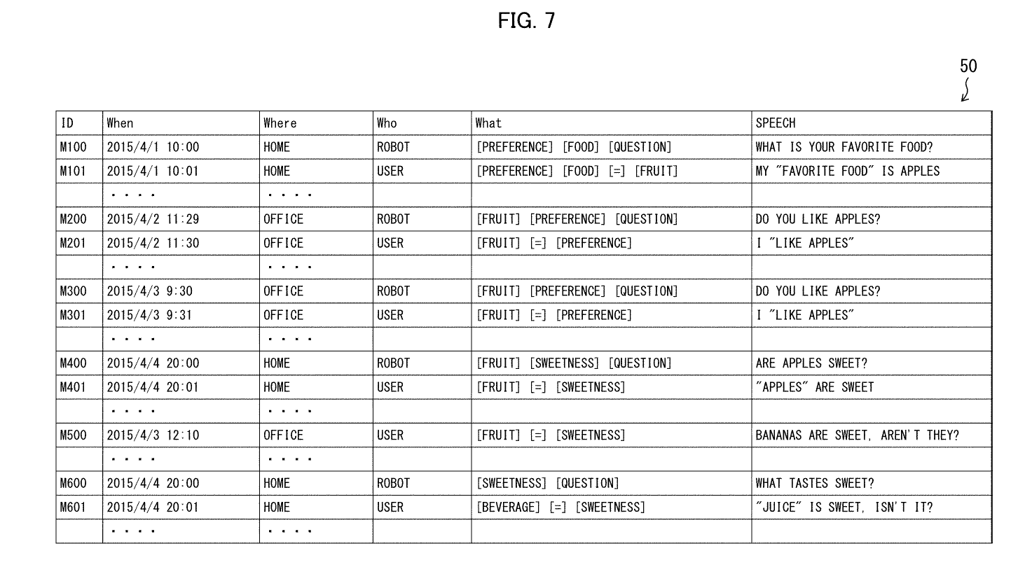

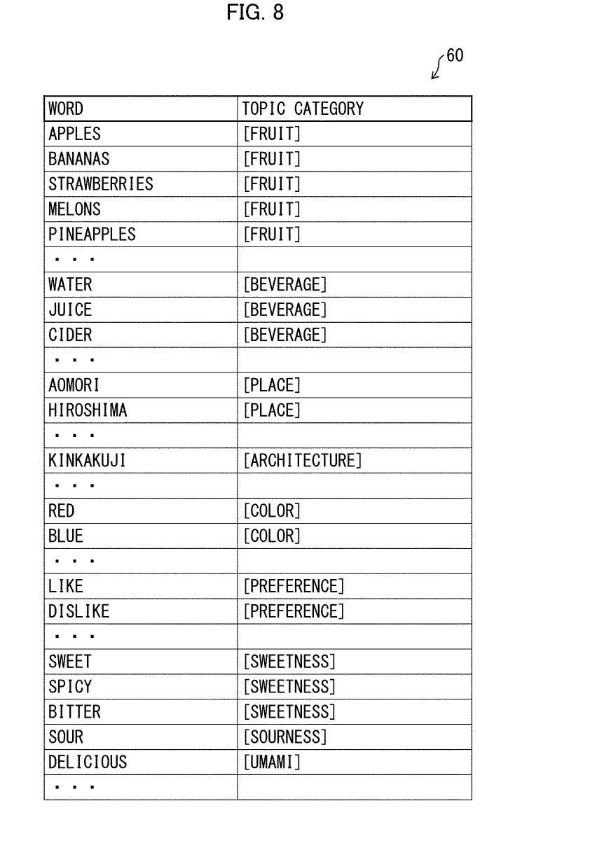

Next, the speech storing section 25 determines a topic category of each word contained in the user's speech, with reference to the category table 60 (see FIG. 8). The speech storing section 25 adds, to the information of the user's speech, information of the topic category of every word contained in the user's speech, as accompanying information. For example, in a case where the user's speech is “I like apples”, the speech storing section 25 adds, to the information of this user's speech, the accompanying information item “fruit”, which is a topic category associated with “apples”, and the accompanying information item “preference”, which is a topic category associated with “like”. The speech storing section 25 stores, in the speech database 50 (see FIG. 7), the information of the user's speech which has the accompanying information items added thereto (S8, speech storing step). Note that the accompanying information may be used to generate a speech of the interactive device 1. For example, in a case where, in the speech database 50, information of the user's previous speech “I bought a cake” has added thereto accompanying information of the time at which the user's speech was inputted, the interactive device 1 can obtain a scenario that contains the same topic category as the user's speech from the scenario database 40 and generate a speech like “Have you eaten the cake you bought yesterday?”, “The cake you bought on last year's birthday was good, wasn't it?”, or the like. In a case where, in the speech database 50, information of the user's previous speech “The scenery from here is great, isn't it?” has added thereto accompanying information of the place and time at which the user's speech was inputted, the interactive device 1 can obtain a scenario that contains the same topic category as the user's speech from the scenario database 40 and generate a speech like “The Great Seto Bridge we saw in one evening last month was great, wasn't it?”.

In a case where the completion processing section completes the user's speech in step S7, the completed user's speech may be different from the user's intended one. For example, in a case where the user says “sweet”, the completion processing section 23 completes the user's speech by adding a subject that was seemingly omitted in the user's speech; however, the subject added by the completion processing section 23 may be different from the user's intended subject. To address this, the correct/incorrect determination section 26 determines whether the completed user's speech is correct or incorrect on the basis of a specified determination condition, and, only if it is determined that the completed user's speech is correct, the speech storing section 25 stores the information of the completed user's speech in the speech database 50. The determination of whether the completed user's speech is correct or incorrect, carried out by the correct/incorrect determination section 26, can be made on the basis of any determination condition. For example, the correct/incorrect determination section 26 may use information of the user's immediately preceding speech or information of the immediately preceding speech of the interactive device 1 to determine whether the completed user's speech is correct or incorrect. One example of the speech storing process (S8) carried out by the correct/incorrect determination section 26 will be described later. With this, the speech information obtaining process ends.

According to the above-described speech information obtaining process, it is possible to store a user's speech in complete state, that is, in a state having no phrases omitted, in the speech database 50. Information of user's previous speeches stored in the speech database 50 can be used to generate a speech of the interactive device 1. A method of generating a speech of the interactive device 1 with the use of the information of the user's previous speeches stored in the speech database 50 will be described later.

(S1: Flow of Speech Generation Process)

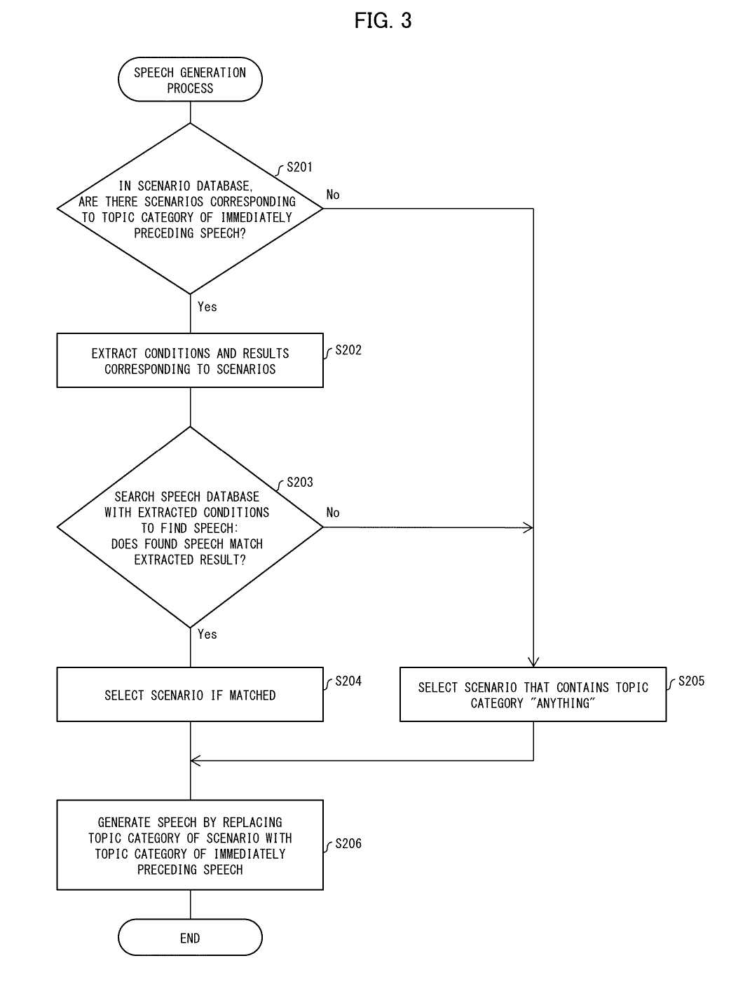

The following description will discuss a flow of step S1 of the foregoing speech information obtaining process (see FIG. 2), that is, a flow of the speech generation process, with reference to FIGS. 3 and 4. FIG. 3 is a flowchart showing a flow of the speech generation process S1. FIG. 4 illustrates one example of a data structure of the scenario database 40. As illustrated in FIG. 4, the scenario database 40 contains a plurality of scenarios including scenarios of questions from the interactive device 1 to a user. The scenario database 40 may further contain a scenario for use in generation of a speech other than questions (e.g., call, notice, or the like) of the interactive device 1 (this arrangement is not illustrated).

As shown in FIG. 3, in the speech generation process, first, the speech generation section 24 refers to information of a topic category associated with the information of the user's immediately preceding speech in the speech database 50 (that is, the speech generation section 24 refers to information of a topic category associated with the most recently stored one of the information items of user's previous speeches stored in the speech database 50).

Next, the speech generation section 24 searches the scenario database 40 (illustrated in FIG. 4) for scenarios containing the same topic category as the topic category associated with the user's immediately preceding speech (S201). If there are no scenarios containing the same topic category as the topic category associated with the user's immediately preceding speech in the scenario database 40 (No in S201), the speech generation section 24 selects, from the scenario database 40, a scenario that contains a different topic category from the topic category associated with the user's immediately preceding speech (for example, selects a scenario that contains the topic category “ANYTHING” in FIG. 4) (S205). In this case, it is preferable that the topic category of a speech of the interactive device 1, generated by the speech generation section 24, is similar to, for example, the topic category of the user's immediately preceding speech (that is, it is preferable that the topic category of the speech of the interactive device 1 is included in the same superordinate category [described later] as the topic category of the user's immediately preceding speech).

The speech generation section 24 generates a next speech of the interactive device 1 by replacing the topic category of the scenario selected in S205 with the topic category of the user's preceding speech or with the topic category of the preceding speech of the interactive device 1 (S206, speech generating step). Note that, if there are no scenarios containing the same topic category as the topic category associated with the user's immediately preceding speech in the scenario database 40 (No in S201), the interactive device 1 may respond to the user's speech by an action such as back-channel feedback, without outputting any speech. Alternatively, in a case where the topic category of the next speech of the interactive device 1 differs greatly from the topic category of the user's immediately preceding speech, the speech generation section 24 may generate a speech that informs the user of a topic change (e.g., “By the way”).

On the other hand, if there are scenarios containing the same topic category as the topic category associated with the user's immediately preceding speech in the scenario database 40 (Yes in S201), the speech generation section 24 extracts conditions and results associated with the scenarios (see FIG. 4) from the scenario database 40 (S202). The speech generation section 24 also searches the speech database 50 for information of a user's preceding speech or a preceding speech of the interactive device 1 that satisfies one of the conditions corresponding to the scenarios extracted in S202 (S203).

If there is no information of a user's preceding speech or a preceding speech of the interactive device 1 that satisfies one of the conditions and results corresponding to the scenarios extracted in S202 in the speech database 50 (No in S203), the speech generation section 24 selects, from the scenario database 40, a scenario that contains a different topic category from the topic category associated with the user's immediately preceding speech (S205). On the other hand, if there is information of a user's preceding speech or a preceding speech of the interactive device 1 that satisfies one of the conditions and results corresponding to the scenarios extracted in S202 in the speech database 50 (Yes in S203), the speech generation section 24 selects one of the extracted scenarios (S204). Then, the speech generation section 24 generates a next speech of the interactive device 1 by replacing the topic category of the scenario selected in S204 or S205 with the topic category of the user's preceding speech or the preceding speech of the interactive device 1 (S206, speech generating step). With this, the speech generation process ends.

(S7: Flow of Speech Completion Process)

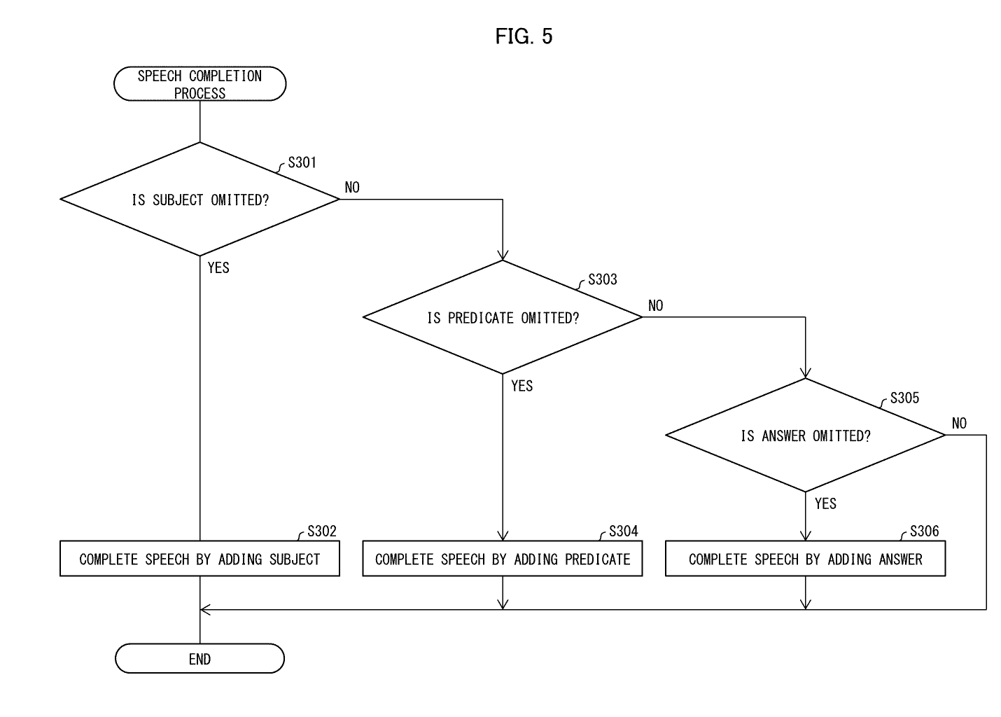

The following description will discuss a flow of step S7 of the foregoing speech information obtaining process (see FIG. 2), that is, a flow of the speech completion process, with reference to FIG. 5. FIG. 5 is a flowchart showing a flow of the speech completion process S7.

As shown in FIG. 5, in the speech completion process, first, the completion processing section 23 determines whether or not the subject is omitted in the user's speech obtained as a result of the morphological analysis by the morphological analysis section 22 (S301). If it is determined that the subject is omitted in the user's speech (YES in S301), the completion processing section 23 completes the user's speech by adding a subject to the user's speech (S302).

Specifically, the completion processing section 23 refers to the speech database 50 to obtain information of the immediately preceding speech of the interactive device 1 (that is, the completion processing section 23 obtains the most recently stored one of the information items of previous speeches of the interactive device 1 stored in the speech database 50). Then, the completion processing section 23 completes the user's speech by adding a subject to the user's speech, based on the subject of the immediately preceding speech of the interactive device 1. For example, in a case where the interactive device 1 says “Do you like grapes?” in accordance with “Scenario 2” in the scenario database 40 shown in FIG. 4 and thereafter the user says “like them (grapes)”, the completion processing section 23 may complete the user's speech by adding the subject “You” that was omitted in the user's speech, thereby generating the completed user's speech “XX (registered name of the user) likes grapes”. Alternatively, the completion processing section 23 may generate the speech “like grapes”, without including the user's registered name in the completed user's speech. In another example, in a case where the user says “Apples are delicious” and thereafter says “I like very much”, the completion processing section 23 may carry out a completing process with respect to the user's speech “I like very much” to thereby generate the completed user's speech “I like apples very much”, based on the user's preceding speech “Apples are delicious”. Like this example, the completion processing section 23 may complete the user's speech on the basis of the preceding speech (of the interactive device 1 or the user) other than the questions from the interactive device 1. In one variation, in a case where, in the scenario database 40, each scenario is associated with a completing scenario that is used to complete a user's speech, the completion processing section 23 may complete the user's speech in accordance with the completing scenario. For example, the following arrangement may be employed: in a completing scenario, a part(s) (word(s)) or a phrase(s) in a sentence is/are blank; and the blank is filled in on the basis of the user's speech such that one whole sentence corresponding to the completed user's speech is obtained.

In a case where the subject is not omitted in the user's speech (NO in S301), the completion processing section 23 next determines whether or not the predicate was omitted in the user's speech (S303). If it is determined that the predicate was omitted in the user's speech (YES in S303), the completion processing section 23 completes the user's speech by adding a predicate to the user's speech on the basis of the immediately preceding speech of the interactive device 1 (S304). For example, in a case where the immediately preceding speech of the interactive device 1 is “Do you like grapes?” and the user said “I do”, the completion processing section 23 generates the completed user's speech “XX (registered name of the user) likes grapes”. The completion processing section 23 may further carry out a step of adding a modifier to the user's speech (this arrangement is not illustrated).

If it is determined that the predicate is not omitted in the user's speech (NO in S303), the completion processing section 23 next determines whether or not the answer was shortened in the user's speech (S305). That is, the completion processing section 23 determines whether the user's speech is “Yes” or the like affirmative response or “NO” or the like negative response. If it is determined that the answer is shortened in the user's speech (YES in S305), the completion processing section 23 refers to the speech database 50 (see FIG. 7) to obtain information of the immediately preceding speech of the interactive device 1. Then, the completion processing section 23 completes the user's speech on the basis of the immediately preceding speech of the interactive device 1 (S306). For example, in a case where the immediately preceding speech of the interactive device 1 is “Do you like grapes?” and the user said “No” (negative response), the completion processing section 23 generates the completed user's speech “XX (registered name of the user) does not like grapes”.

If it is determined that none of the phrases in the user's speech is omitted (NO in S305), the completion processing section 23 does not carry out the speech completion process with respect to the user's speech.

(S8: Flow of Speech Storing Process)

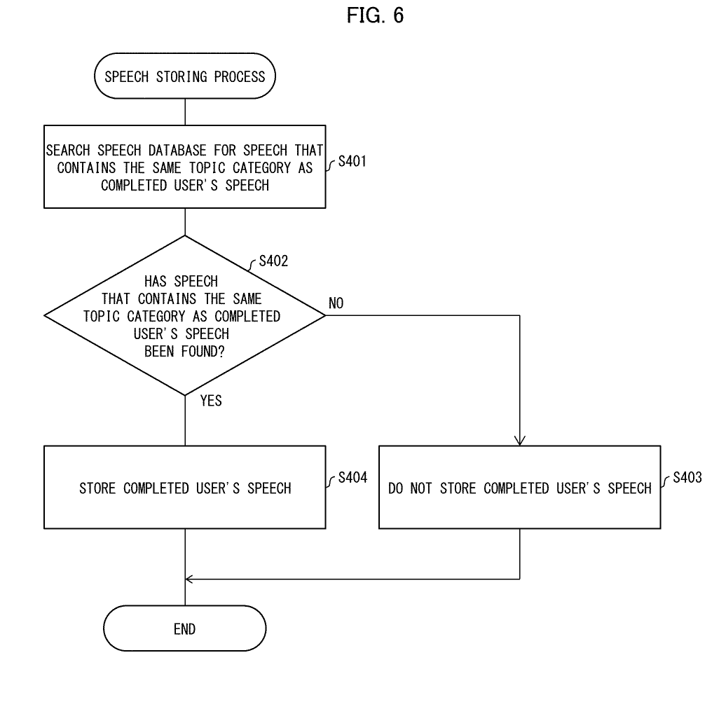

The following description will discuss a flow of step S8 of the foregoing speech information obtaining process, that is, a flow of the speech storing process, with reference to FIG. 6. FIG. 6 is a flowchart showing a flow of the speech storing process S8. The following discusses a flow of the speech storing process in cases where the completion processing section 23 completes a user's speech.

As shown in FIG. 6, in the speech storing process, first, the correct/incorrect determination section 26 searches the speech database 50 for information of a user's previous speech associated with the same topic category as a topic category of a word contained in the user's speech completed by the completion processing section 23 (S401, correct/incorrect determining step).

If the correct/incorrect determination section 26 fails to find information of a user's previous speech associated with the same topic category as a topic category of a word contained in the completed user's speech (NO in S402), the correct/incorrect determination section 26 determines that the completed user's speech is incorrect. In this case, the speech storing section 25 does not store the information of the completed user's speech in the speech database 50 (S403). Note however that, if the correct/incorrect determination section 26 determines that the completed user's speech is incorrect, the interactive device 1 may ask the user whether the completed user's speech is correct or incorrect. In this arrangement, if the user's answer is that the completed user's speech is appropriate, the speech storing section 25 also stores, in the speech database 50, the completed user's speech that has been determined to be incorrect by the correct/incorrect determination section 26. This arrangement will be described later in Embodiment 3.

On the other hand, if the correct/incorrect determination section 26 succeeds in finding information of a user's previous speech associated with the same topic category as a topic category of a word contained in the completed user's speech (YES in S402), the correct/incorrect determination section 26 determines that the completed user's speech is correct. In this case, the speech storing section 25 stores the information of the user's speech completed by the completion processing section 23 in the speech database (S404). Note that, in a case where the completion processing section 23 did not carry out the completing process with respect to the user's speech in step S7 of the speech information obtaining process, the correct/incorrect determination section 26 may not carry out the determination of whether or not the user's speech is correct or incorrect, and the speech storing section 25 may store the user's speech which has not been subjected to the completing process.

(Variation)

In one variation, the correct/incorrect determination section 26 may determine whether the completed user's speech is correct or incorrect on the basis of not only the condition in terms of topic category of the completed user's speech but also a condition in terms of who (which user) made the speech. According to the arrangement of this variation, whether the completed user's speech is correct or incorrect is determined based on an increased number of conditions, and therefore it is possible to more accurately determine whether the completed user's speech is correct or incorrect.

In this variation, if the correct/incorrect determination section 26 succeeds in finding, from the speech database 50, information of a user's previous speech associated with the same topic category as a topic category of the completed user's speech (YES in S402 of FIG. 6), the correct/incorrect determination section 26 refers to accompanying information added to the information of the found previous speech to thereby identify who (that is, which user) made the found previous speech. Then, the correct/incorrect determination section 26 determines, if the speaker (the person who made the speech) is the same between the completed speech and the found previous speech, that the completed user's speech is correct. The correct/incorrect determination section 26 may refer to, for example, identification information items (such as registered name or registered number) of users that have been registered with the interactive device 1, in order to determine who made the found previous speech.

(Example of Speech Database 50)

FIG. 7 illustrates one example of a data structure of the speech database 50, in which information items of user's previous speeches and previous speeches of the interactive device 1 are stored. Note here that the “ROBOT” shown in the “Who” column of the speech database 50 in FIG. 7 corresponds to the interactive device 1. As shown in FIG. 7, the speech database 50 stores therein information items of respective speeches of the robot (i.e., interactive device 1) and a user(s). Furthermore, in the speech database 50 shown in FIG. 7, each of the information items of the respective speeches of the robot and the user(s) is provided with accompanying information items concerning “When” (time and date of the speech), “Where” (place of the speech), “Who” (who made the speech), and “What” (topic category[categories] associated with the speech). In FIG. 7, each of the information items of the speeches is provided with information of a plurality of topic categories (in “What” column) as accompanying information. Furthermore, in FIG. 7, the expression “A=B” in the topic category column (i.e., “What” column) in regard to a certain speech is intended to mean that the certain speech contains one word associated with the topic category “A” and another word associated with the topic category B. The expression “AB=C” in the topic category column (i.e., “What” column) in regard to another speech is intended to mean that the another speech contains one word associated with the topic categories “A” and “B” and another word associated with the topic category C.

The following arrangement, which is not illustrated, may be employed: in the speech database 50, an information item of a user's previous speech is provided with (i) an accompanying information item that is indicative of a means (voice input, text input) via which the speech was inputted into the interactive device 1 or (ii) an accompanying information item that is indicative of the state (having been subjected to the completing process or not) of the speech when the speech was stored in the speech database 50.

(Example of Category Table 60)

FIG. 8 illustrates one example of a data structure of the category table 60, which shows a correspondence relationship between words and their corresponding topic categories. For example, in FIG. 8, the word “APPLE” is associated with the topic category “FRUIT”. In the category table 60 shown in FIG. 8, each word is associated with one topic category; however, information of each word may be associated with information of one or more topic categories.

Some of the topic categories may be in inclusion relation with each other. Specifically, a word associated with a certain topic category may be one of the words that are associated with another topic category (superordinate category). For example, the topic categories “SWEETNESS”, “SOURNESS”, and “UMAMI” in FIG. 8 may be included in the superordinate category “TASTE” (not shown). The topic categories included in the same superordinate category (such as “SWEETNESS” and “SOURNESS”, “SWEETNESS” and “UMAMI”) are similar to each other. It is preferable that the foregoing speech generation section 24, when generating a speech of the interactive device 1, generates the speech of the interactive device 1 in accordance with a scenario that contains the same topic category as that of the user's immediately preceding speech or in accordance with a scenario that contains a similar topic category to that of the preceding user's speech.

### Embodiment 2

In the speech storing process S8 of Embodiment 1, the correct/incorrect determination section 26 determines that the completed user's speech is correct if a topic category of a word contained in the completed user's speech is the same as a topic category of a user's previous speech (see FIG. 6). Embodiment 2 deals with an arrangement in which the correct/incorrect determination section 26 determines whether the completed user's speech is correct or incorrect in a different manner from that described in Embodiment 1.

(S8: Flow of Speech Storing Process)

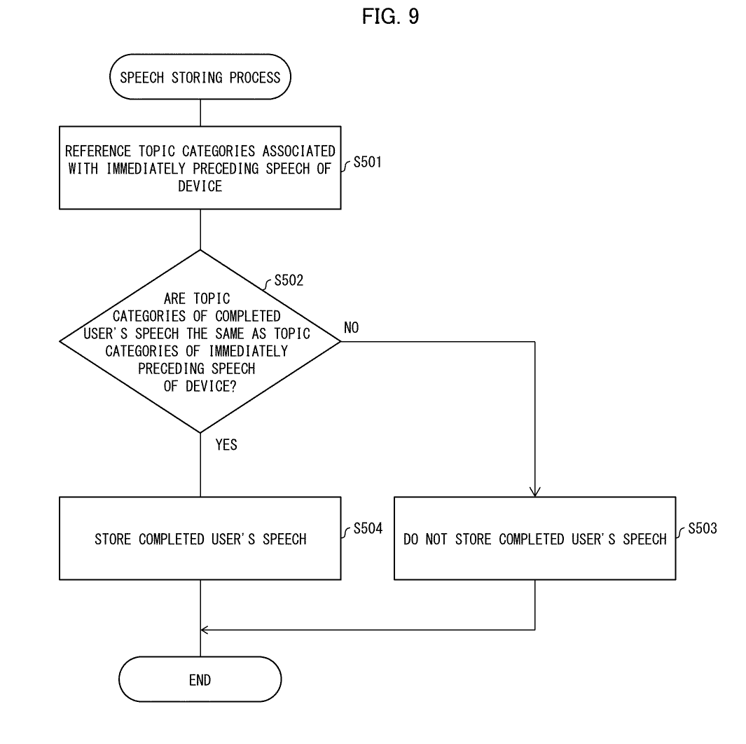

The following description will discuss a flow of a speech storing process S8 in accordance with Embodiment 2 with reference to FIG. 9. FIG. 9 is a flowchart showing a flow of the speech storing process in accordance with Embodiment 2. The following discusses a flow of the speech storing process in a case where the completion processing section 23 completes a user's speech.

As shown in FIG. 9, in the speech storing process in accordance with Embodiment 2, first, the correct/incorrect determination section 26 refers to information of a combination of topic categories associated with the immediately preceding speech of the interactive device 1 in the speech database 50 (that is, the correct/incorrect determination section 26 refers to information of a combination of topic categories associated with the most recently stored one of the information items of previous speeches of the interactive device 1 stored in the speech database 50) (S501).

If a combination of topic categories of a plurality of words contained in the completed user's speech is not the same as the combination of topic categories associated with the immediately preceding speech of the interactive device 1 (NO in S502), the speech storing section 25 does not store the information of the completed user's speech in the speech database 50 (S503). Note that the following arrangement, like that described later in Embodiment 3, may be employed: if the correct/incorrect determination section 26 determines that the completed user's speech is incorrect, the interactive device 1 asks the user whether the completed user's speech is correct or incorrect. In this arrangement, if the user answers that the completed user's speech is appropriate, the speech storing section 25 also stores, in the speech database 50, the completed user's speech that has been determined to be incorrect by the correct/incorrect determination section 26.

On the other hand, if a combination of topic categories of a plurality of words contained in the completed user's speech is the same as the combination of topic categories associated with the immediately preceding speech of the interactive device 1 (YES in S502), the speech storing section 25 stores the information of the completed user's speech in the speech database 50 (S504). Note that, if the completion processing section 23 does not carry out the completing process with respect to the user's speech in step S7 of the speech information obtaining process, the correct/incorrect determination section 26 may or may not carry out the determination of whether the user's speech is correct or incorrect. In a case where the correct/incorrect determination section 26 does not carry out the determination of whether the user's speech is correct or incorrect, the speech storing section 25 may store the user's speech that has not been subjected to the completing process.

In a case where the interactive device 1 and a user are having a conversation about a certain topic, the user's speech is closely related to the immediately preceding speech of the interactive device 1. On the other hand, if the user has changed topics, the user's speech is less related to the immediately preceding speech of the interactive device 1. As described earlier, the completion processing section 23 completes the user's speech on the basis of the immediately preceding speech of the interactive device 1, and therefore the completion processing section 23 is highly likely to be able to correctly complete the user's speech in the former case; however, in the latter case, the completion processing section 23 is less likely to be able to correctly complete the user's speech. According to the arrangement of Embodiment 2, the speech storing section 25 stores the completed user's speech in the speech database 50 only if the topic categories of the words contained in the completed user's speech are the same as the topic categories of the words contained in the immediately preceding speech of the interactive device 1, that is, only in the former case. As such, the speech storing section 25 is capable of storing, in the speech database 50, only information of a user's speech that is highly likely to have been completed correctly.

Note that the speech storing process discussed in Embodiment 2 and the speech storing process discussed in Embodiment 1 may be employed in combination. For example, the following arrangement may be employed. As described earlier in Embodiment 1, the correct/incorrect determination section 26 first determines whether or not a topic category of a word contained in the completed user's speech is the same as a topic category of a user's previous speech. If it is determined that the topic category of a word contained in the completed user's speech is the same as a topic category of a user's pervious speech, the correct/incorrect determination section 26 determines that the completed user's speech is correct. On the other hand, if it is determined that the topic category of a word contained in the completed user's speech is not the same as a topic category of a user's pervious speech, the correct/incorrect determination section 26 further carries out a determination of whether the completed user's speech is correct or incorrect in the manner described in Embodiment 2. According to this arrangement, the correct/incorrect determination section 26 is capable of more accurately determining whether the completed user's speech is correct or incorrect.

### Embodiment 3

Embodiment 3 deals with an arrangement in which, if the speech storing section 25 determines not to store the completed user's speech in the speech storing process S8 of the speech information obtaining process (see FIG. 2) described earlier in Embodiments 1 and 2, the speech generation section 24 asks the user whether the completed user's speech is correct or incorrect.

(Speech Confirmation Process)

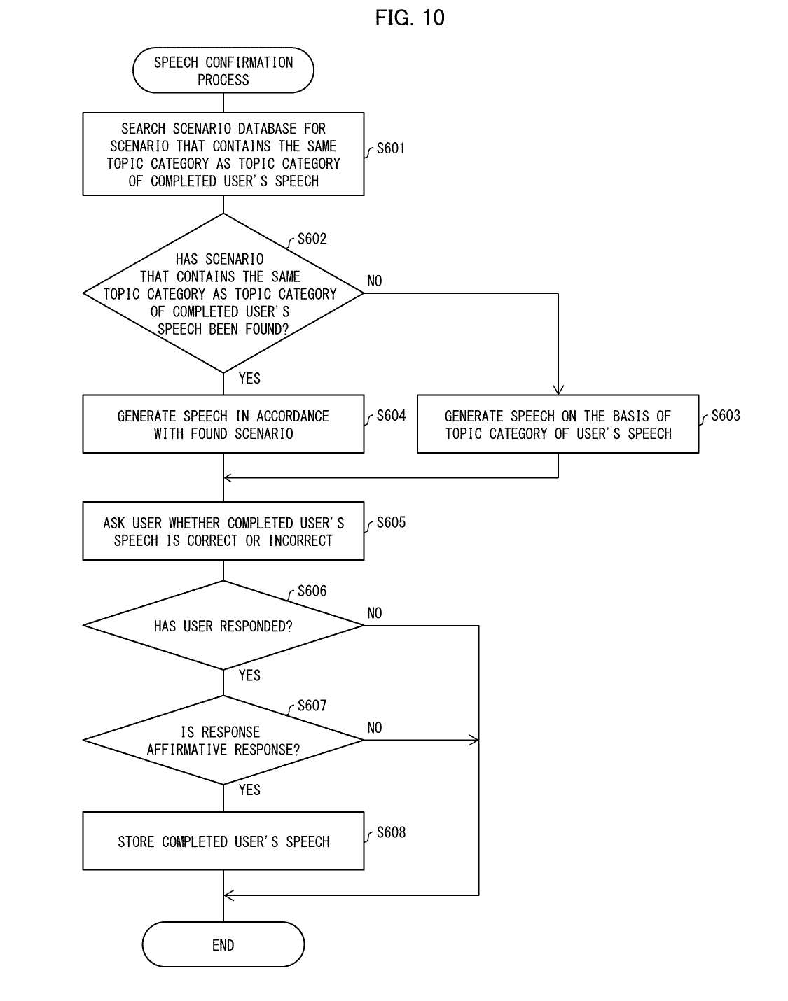

The following description will discuss a flow of a speech confirmation process in accordance with Embodiment 3, with reference to FIG. 10. If the speech storing section 25 determines not to store the completed user's speech in the speech storing process (see FIGS. 6 and 9) described earlier in Embodiments 1 and 2, the control section 20 carries out the following speech confirmation process.

As shown in FIG. 10, in the speech confirmation process, first, the speech generation section 24 searches the scenario database 40 for a scenario that contains the same topic category as or a similar topic category to a topic category of a word contained in the completed user's speech (S601).

If the speech generation section 24 fails to find a scenario that contains the same topic category as that of a word contained in the completed user's speech from the scenario database 40 (NO in S602), the speech generation section 24 generates a speech of the interactive device 1 on the basis of the topic category of the user's speech (S603). For example, in a case where the completed user's speech is “Lemons are sweet”, the speech generation section 24 generates a speech of the interactive device 1 on the basis of a topic category (e.g., fruit) associated with “lemons” and a topic category (e.g., sweetness) associated with “sweet”. For example, the speech generation section 24 may generate the speech “Are lemons sweet?” as a speech of the interactive device 1. In a case where the user's speech which has not been subjected to the completing process is “sweet”, the morphological analysis section 22 carries out a morphological analysis of the user's speech to thereby determine that the subject ([What]) was omitted in the user's speech. Then, the speech generation section 24 may generate the speech “What tastes sweet?” as a speech of the interactive device 1, on the basis of the result of the morphological analysis by the morphological analysis section 22 and the topic category “sweet” which is associated with the user's speech.

On the other hand, if the speech generation section 24 succeeds in finding a question scenario that contains the same topic category as that of the completed user's speech from the scenario database 40 (YES in S602), the speech generation section 24 generates a speech of the interactive device 1 in accordance with the found question scenario (S604). For example, if the completed user's speech is “Lemons are sweet”, the speech generation section 24 obtains, from the scenario database 40, a question scenario that contains topic categories corresponding to “lemon” and “sweet” (such topic categories are, for example, fruit, sweetness, sourness, umami, and the like). Then, the speech generation section 24 may generate a speech of the interactive device 1 in accordance with the obtained question scenario. For example, in a case where the question scenario obtained by the speech generation section 24 is “Is(Are) [A] [B]?”, the speech generation section 24 may replace [A] with “lemons” and replace [B] with “sweet”, and thereby generate the speech “Are lemons sweet?” as a speech of the interactive device 1.

The speech generation section 24 causes the speech output section 30 to output the thus-generated speech (question) of the interactive device 1 (S605). Then, the control section 20 of the interactive device 1 waits for a certain period of time to receive a user's response to the speech of the interactive device 1.

If the user does not respond within the certain period of time after the speech of the interactive device 1 (No in S606), the speech storing process ends. On the other hand, if the user responds within the certain period of time (Yes in S606), the correct/incorrect determination section 26 determines whether the user's response is affirmative (such as “Yes” or “Yep”) or negative (such as “No” or “Nope”) (S607). If the user's response is affirmative (YES in S607), the speech storing section 25 stores the completed user's speech in the speech database 50 (S608). On the other hand, if the user's response is negative (NO in S607), the speech storing section 25 does not store the completed user's speech in the speech database 50.

According to the arrangement of Embodiment 3, if the correct/incorrect determination section 26 determines that the completed user's speech is incorrect, the speech generation section 24 asks the user whether the completed user's speech is correct or incorrect. If the user answers that the completed user's speech is correct, the speech storing section 25 stores the user's speech in the speech database 50. Thus, it is possible to more accurately determine whether the completed user's speech is correct or incorrect. In addition, it is possible to reduce the likelihood that information of a user's speech that is not incorrect (that is, correct) will not be stored in the speech database 50.

[Software Implementation Example]

The control section 20 of the interactive device 1 can be realized by a logic circuit (hardware) provided in an integrated circuit (IC chip) or the like or can be alternatively realized by software as executed by a central processing unit (CPU).

In the latter case, the interactive device 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Recap]

An interactive device (1) in accordance with Aspect 1 of the present invention is an interactive device configured to converse with a user by voice or text, comprising: a speech completion section (completion processing section 23) configured to, if a speech of the user inputted to the interactive device lacks some phrase, complete the speech of the user on the basis of at least one of a previous speech of the interactive device and a previous speech of the user; a correct/incorrect determination section (26) configured to determine whether the speech of the user completed by the speech completion section is correct or incorrect on the basis of a specified determination condition; a speech storing section (25) configured to, if the correct/incorrect determination section determines that the speech of the user is correct, store information of the speech of the user in a speech database (50); and a speech generation section (24) configured to generate a speech of the interactive device with use of the speech of the user that has been stored in the speech database by the speech storing section.

According to the above arrangement, it is possible to generate a speech of the interactive device with the use of information of a user's speech inputted to the interactive device. Furthermore, if the user's speech lacks some phrase, the user's speech is completed. It follows that information of a complete user's speech with no lack of phrases is stored in the speech database. This makes it possible for the interactive device to generate a speech of the interactive device by making effective use of a user's speech stored in the speech database.

An interactive device in accordance with Aspect 2 of the present invention may be arranged such that, in Aspect 1, the speech completion section is configured to complete the speech of the user on the basis of a word that is contained in the at least one of the previous speech of the interactive device and the previous speech of the user. Note that, if information of both the previous speech of the interactive device and the previous speech of the user are stored in the speech database, the speech completion section may complete the speech of the user on the basis of the speech of the interactive device or of the user most recently stored in the speech database.

According to the above arrangement, it is possible to easily complete the speech of the user on the basis of a topic of a previous conversation between the interactive device and the user. For example, if at least one of the interactive device and the user previously talked about some topic related to a certain word, the certain word is highly likely to be contained in a subsequent speech of the user. As such, if the certain word is added to the speech of the user to complete the speech, the completed speech of the user is highly likely to be correct.

An interactive device in accordance with Aspect 3 of the present invention may be arranged such that, in Aspect 1 or 2, the correct/incorrect determination section is configured to (a) refer to information indicative of a correspondence relationship between words and categories thereof, and (b) if a category of a word that is contained in the speech of the user completed by the speech completion section is the same as a category of a word that is contained in the at least one of the previous speech of the interactive device and the previous speech of the user, determine that the speech of the user is correct.

According to the above arrangement, it is possible to easily determine that the completed user's speech is correct or incorrect. This makes it possible to selectively store, in the speech database, only information of user's speeches that are highly likely to be correct.

An interactive device in accordance with Aspect 4 of the present invention may be arranged such that, in any of Aspects 1 to 3, the speech storing section is configured to store, in the speech database, the speech of the user and at least one of (i) information indicative of one or more categories of one or more words that are contained in the speech of the user, (ii) information indicative of date and time or place at which the speech of the user was inputted, and (iii) identification information of the user.

According to the above arrangement, it is possible to improve the accuracy of determination of whether the speech of the user is correct or incorrect, by making use of the information stored in the speech database.

An interactive device in accordance with Aspect 5 of the present invention may be arranged such that, in any of Aspects 1 to 4, the correct/incorrect determination section is configured to (a) refer to information indicative of a correspondence relationship between words and categories thereof, and (b) if a combination of categories corresponding to a plurality of words that are contained in the speech of the user completed by the speech completion section is the same as a combination of categories corresponding to a plurality of words that are contained in at least one of a speech of the interactive device and a speech of the user which are stored in the speech database, determine that the speech of the user completed by the speech completion section is correct.

According to the above arrangement, it is possible to more accurately determine whether the speech of the user is correct or incorrect, on the basis of a combination of categories of a plurality of words that are contained in at least one of a previous speech of the interactive device and a previous speech of the user.

An interactive device in accordance with Aspect 6 of the present invention may be arranged such that, in any of Aspects 1 to 5, the correct/incorrect determination section is configured to (a) output a speech, of the interactive device, which asks the user whether the speech of the user completed by the speech completion section is correct or incorrect, and (b) if a speech, of the user, which indicates that the speech of the user completed by the speech completion section is correct is inputted to the interactive device, determine that the speech of the user completed by the speech completion section is correct.

According to the above arrangement, it is possible to more accurately determine whether the completed speech of the user is correct or incorrect.

A method of controlling an interactive device in accordance with Aspect 7 of the present invention is a method of controlling an interactive device (1) that is configured to converse with a user by voice or text, the method including: a speech completing step including, if a speech of the user inputted to the interactive device lacks some phrase, completing the speech of the user on the basis of at least one of a previous speech of the interactive device and a previous speech of the user; a correct/incorrect determining step including determining whether the speech of the user completed in the speech completing step is correct or incorrect on the basis of a specified determination condition; a speech storing step including, if it is determined in the correct/incorrect determining step that the speech of the user is correct, storing information of the speech of the user in a speech database (50) that is for use in generation of a speech of the interactive device; and a speech generating step including generating the speech of the interactive device with use of the speech of the user that has been stored in the speech database in the speech storing step. According to this arrangement, it is possible to provide similar effects to those of the interactive device in accordance with Aspect 1.

The interactive device according to the foregoing embodiments of the present invention may be realized by a computer. In this case, the present invention encompasses: a control program for the interactive device which program causes a computer to operate as the foregoing sections (software elements) of the interactive device so that the interactive device can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 interactive device
23 completion processing section (speech completion section)
24 speech generation section
25 speech storing section
26 correct/incorrect determination section
50 speech database

1. An interactive device configured to converse with a user by voice or text, comprising:
a speech completion section configured to, if a speech of the user inputted to the interactive device lacks some phrase, complete the speech of the user on the basis of at least one of a previous speech of the interactive device and a previous speech of the user;
a correct/incorrect determination section configured to determine whether the speech of the user completed by the speech completion section is correct or incorrect on the basis of a specified determination condition;
a speech storing section configured to, if the correct/incorrect determination section determines that the speech of the user is correct, store information of the speech of the user in a speech database; and
a speech generation section configured to generate a speech of the interactive device with use of the speech of the user that has been stored in the speech database by the speech storing section.

2. The interactive device according to claim 1, wherein the speech completion section is configured to complete the speech of the user on the basis of a word that is contained in the at least one of the previous speech of the interactive device and the previous speech of the user.

3. The interactive device according to claim 1, wherein the correct/incorrect determination section is configured to
(a) refer to information indicative of a correspondence relationship between words and categories thereof, and
(b) if a category of a word that is contained in the speech of the user completed by the speech completion section is the same as a category of a word that is contained in the at least one of the previous speech of the interactive device and the previous speech of the user, determine that the speech of the user is correct.

4. The interactive device according to claim 1, wherein the speech storing section is configured to store, in the speech database, the speech of the user and at least one of (i) information indicative of one or more categories of one or more words that are contained in the speech of the user, (ii) information indicative of date and time or place at which the speech of the user was inputted, and (iii) identification information of the user.

5. The interactive device according to claim 1, wherein the correct/incorrect determination section is configured to
(a) refer to information indicative of a correspondence relationship between words and categories thereof, and
(b) if a combination of categories corresponding to a plurality of words that are contained in the speech of the user completed by the speech completion section is the same as a combination of categories corresponding to a plurality of words that are contained in at least one of a speech of the interactive device and a speech of the user which are stored in the speech database, determine that the speech of the user completed by the speech completion section is correct.

6. The interactive device according to claim 1, wherein the correct/incorrect determination section is configured to
(a) output a speech, of the interactive device, which asks the user whether the speech of the user completed by the speech completion section is correct or incorrect, and
(b) if a speech, of the user, which indicates that the speech of the user completed by the speech completion section is correct is inputted to the interactive device, determine that the speech of the user completed by the speech completion section is correct.

7. A method of controlling an interactive device that is configured to converse with a user by voice or text, the method comprising:
a speech completing step comprising, if a speech of the user inputted to the interactive device lacks some phrase, completing the speech of the user on the basis of at least one of a previous speech of the interactive device and a previous speech of the user;
a correct/incorrect determining step comprising determining whether the speech of the user completed in the speech completing step is correct or incorrect on the basis of a specified determination condition;
a speech storing step comprising, if it is determined in the correct/incorrect determining step that the speech of the user is correct, storing information of the speech of the user in a speech database that is for use in generation of a speech of the interactive device; and
a speech generating step comprising generating the speech of the interactive device with use of the speech of the user that has been stored in the speech database in the speech storing step.

8. A non-transitory computer-readable storage medium storing a control program for causing a computer to function as an interactive device according to claim 1, the control program causing the computer to function as each of the foregoing sections.
